(19) United States
(12) Patent Application Publication
(10) Pub. No.: US 2012/0073090 A1
(43) Pub. Date: Mar. 29, 2012

(54) Linear clip mount comprising an open track in a tongue mounting an immovable guide in a buckle that locks by a levered and sprung projection

(76) Inventor: David Szellos, (US)

(21) Appl. No.: 12/889,944

(22) Filed: Sep. 24, 2010

(51) Int. Cl. F16B 2/20

(52) U.S. Cl. 24/489

(57) ABSTRACT

A linear mount clip joins a tongue and a bracket using an open track in the tongue to guide the tongue into the bracket. The buckle has an immovable linear guide which serves as an internal guide for the open track until the tongue can be inserted no further. The buckle includes a sprung plate overarching the tongue and incorporating a perforation on the tongue side of the plate as well as a rotating attachment to the immovable linear guide. The angle of rotation of the tongue is perpendicular to the axis of the immovable linear guide. The sprung plate revolves on the axis of the immovable feature. Depressing the plate on its edge will lever the plate and its projection away from the tongue allowing it to be inserted into the buckle bracket. Releasing the plate will cause the projection to lock into a perforation in the tongue. The tongue and bracket and locking device form a buckle that can be used to secure a device to a substrate such as a watch to a watchband.

### CROSS-REFERENCE TO RELATED APPLICATIONS

No cross reference is made to other applications.

### STATEMENT REGARDING FEDERALLY SPONSORED RESEARCH OF DEVELOPMENT

No Federal Government support was received in the development of this Invention.

### SEQUENCE LISTING, TABLE, OR COMPUTER PROGRAM LISTING

No sequence listing, table, or computer program is attached or accompanies this Application.

### PATENTOR

David Szellos is the Sole Inventor of this Utility.

### BACKGROUND OF THIS INVENTION

A simple patent by Payant (U.S. Pat. No. 3,999,251, Dec. 28, 1976) illustrates the three functional requirements of a buckle. Payant describes a belt tongue perforated along the axis of insertion to allow a locking pin to secure the tongue against the buckle bracket. Of particular interest in this patent is a clip designed into the outer bracket portion of the buckle that rotates up to allow pinning of a lap napkin. It operates in a rotary motion perpendicular to the axis of insertion of the tongue. The principles established in this older patent provide structure for the explanation of the Novel nature of the Invention described in this Application. From this patent it can be seen that a buckle is a coupling device. The coupling occurs between a bracket that by complementary shape encloses a tongue that is inserted. Stability of the bracket can be supplied against the force of withdrawal by a locking mechanism attached to the bracket that engages a feature of the tongue either externally on the boundary of a tongue or internally in a perforation of the tongue. A track is an aperture in the tongue open at the end of insertion to allow the tongue to correctly orientate in the bracket opening. It acts in concert with the match between the bracket opening and the cross sectional shape of the tongue. A perforation in the tongue is a closed hole often seen used in locking mechanisms. A projection is a feature that when introduced locks into the perforation. An internal locking mechanism is a locking projection attached to the bracket that completely penetrates the tongue. An external locking mechanism is a locking feature that acts on the outer boundary of the tongue. A locking mechanism can be contained inside the bracket or form part of the external shell of the bracket.

The Invention described in this Application uses a novel tongue with a perforation and an open guide. The Invention described in this Application uses a novel locking mechanism that is rotated perpendicular to the axis of tongue insertion and is formed by part of the external shell of the bracket. The Invention in this Application incorporates an entirely internal device to stabilize the coupling comprising the buckle.

Patents that describe a tongue passing into a bracket include Mallek (U.S. Pat. No. 5,865,562, Feb. 2, 1999). This patent describes a tongue for attachment of dry wall that inserts into a bracket affixed to a substrate. The locking mechanism for this vertically mounted bracket is the weight of gravity. Those in an earthquake region may wish for a more secure locking mechanism to prevent wall dislocation. McLeod (US 20100122411, May 20, 2010) describes a tongue that fits into a tieplate. The tieplate is mounted to a substrate constituted by the bath. The locking mechanism here is a light interference fit based on friction. Hotel owners may wish for a more secure locking mechanism to prevent theft. Levine (U.S. Pat. No. 4,886,297, Dec. 12, 1989) describes a skateboard bracket employing a tongue inserted into a bracket. The locking mechanism is a pin inserted perpendicularly to the axis of the insertion of the tongue. These patents illustrate the principle of an inserted tongue gaining stability from the outline of the cross section of the tongue being complementary to the shape of the bracket. Couplings are prone to failure if torque is applied to the base of the tongue. Couplings are prone to failure if a withdrawal force is applied to the base of the tongue. The coupling designs described above have employed a variety of linear locking mechanisms that are mostly unable to provide resistance to these forces.

The function of stabilization of the coupling of a tongue and a bracket by means of a more sophisticated locking device acting perpendicular to the line of draw of the tongue has been developed in the class of couples called bayonet mounts. In this design the inventors have realized that a rotational stop using a plurality of tabs on the tongue to match a plurality of cavities on the bracket provides a secure stop against the tongue being withdrawn. A rotational stop also allows for reversible mounting and dismounting of the tongue and whatever device is attached to that tongue. Imanari et al. (U.S. Pat. No. 6,554,503, Apr. 29, 2003) describes a bayonet mount for a camera lens that uses the bayonet mount to engage bayonet tabs into the mount main body. Ludwig (U.S. Pat. No. 4,307,954, Dec. 29, 1981) employs a plurality of claws on the lens marginal portion to permit the lens to be axially inserted into the body opening. Avoidance of misalignment is also provided for in the design of the tabs themselves. Fuchi (U.S. Pat. No. 4,660,953, Apr. 28, 1987) provides a similar bayonet mount. All of these devices are for axial insertion of a tongue that is circular in cross section. A bayonet mount takes advantage of a locking mechanism that is perpendicular to the line of draw. Application of torque or force of withdrawal acts against the material integrity of the bayonet mount bracket.

A disadvantage of traditional bayonet mounts is apparent when considering space occupied by the mount itself. When the tongue is circular this results in a coupling with a large volume. When the device attached to the tongue need not be circular the bayonet mount can still be used in a smaller form. Schadhauser (U.S. Pat. No. 6,893,282, May 17, 2005) describes a bayonet mount for a lamp wherein a rectangular tongue is mounted perpendicular to an inserted rod tongue. Once the rectangular tip is mounted into a slot bracket attached to a substrate wall it is then rotated to provide a locking mechanism that is perpendicular to the line of draw. As with most bayonet mounts the tongue can easily be withdrawn once the bayonet mount is returned to an orientation allowing the plurality of projections on the tongue to be match the complementary plurality of cavities on the mount. The Schadhauser patent is of interest to this application because it makes use of a bayonet mount without the volume of a cylindrical tongue. An extension of this principle is providing a rotating locking device with a spring that rotates to lock albeit with a limited angle of rotation.

A contrast mount between a tongue and a bracket to form a buckle coupling assembly may be seen in the patent by Thorsel (U.S. Pat. No. 4,394,808, Jul. 26, 1983) describing a tongue inserting into a bracket. The tongue in this case is a flat spring that clips against the bracket by virtue of a ramp and release feature. Although the clip is removable the strength of the locking mechanism is only as strong as the spring in the clip itself. Application of force or torque to the base of the clip will also rotate the clip feature of the tongue to be less than perpendicular to the locking feature of the bracket. This leads to a failure in coupling when the strength of the spring becomes less than that of the force applied.

Engineering efforts into the provision of safe seat belts separate the tongue insertion and the locking mechanism into two parts to avoid coupling failure. A seat belt buckle consists of a bracket into which a tongue is inserted. Falb et. al (U.S. Pat. No. 7,797,803, Sep. 21, 2010) use a tongue with a closed perforation. The tongue is inserted into the bracket displacing a separate spring loaded projection. The structural integrity of the coupling is provided both by the fit between the tongue outline and the complementary bracket shape and the internal locking mechanism. There is no guiding open track in the tongue. There is no internal stability afforded by an internal locking between a guiding channel and an immovable feature of the bracket. Depressing a button in the side of the bracket does effect a rotary movement to release the locking mechanism. The axis of that rotation is perpendicular to the axis of the insertion of the tongue. Shimizu et al. (U.S. Pat. No. 5,274,890, Jan. 4, 1994) employ a tongue with a plurality of perforations to increase the strength of the internal locking mechanism. A rotary release actuated by a side button is also present. No open track to guide coupling is present in the tongue. No rigid coupling between a tongue guiding track and an immovable feature of the bracket is used. In all cases seat belt buckle designs make us of an internal rotating locking mechanism possibly because the only feature holding the tongue into the bracket is the locking mechanism itself. Murai (U.S. Pat. No. 5,113,556, May 19, 1992) does use a track open at the insertion end of the tongue whose axis is parallel to the axis of insertion. This provides stability to the coupling in that the guiding track in the tongue acts against an internal and immovable feature of the bracket when torque is applied to the base of the tongue. The coupling is weakened by integrating the locking mechanism into the tongue. A combination of torque and withdrawal force applied to the base of the tongue will eventually result in release of the coupling.

The Invention described in this Application selects the strong features in each of these patents for a superior buckle design.

### BRIEF DESCRIPTION OF THIS INVENTION

The Invention described in this application is a linear clip mount comprised of a tongue and a bracket coupling to form a buckle. The tongue is guided into the bracket using an integral open track. The bracket has an immovable linear guide which serves as an internal guide for the open track until the tongue can be inserted no further. The bracket includes a sprung plate overarching the tongue and incorporating a perforation on the tongue side of the plate as well as a rotating attachment to the immovable linear guide. The angle of rotation of the plate is perpendicular to the axis of the immovable linear guide. The sprung plate thus revolves on this axis within the immovable inner guide. Depressing the plate on its edge will lever the plate and its projection away from the tongue. This allows the tongue to be inserted into the buckle. Releasing the plate will cause the projection to lock into a perforation in the tongue. The tongue may be attached to a substrate and in turn secure a device attached to the buckle. Alternatively the tongue may be attached to a device that is to be attached to a substrate on which the buckle is anchored.

This buckle can be incorporated into a portable device such as an electronic device or watch or light. The tongue can be secured by a substrate such as a wrist band or handlebars on a bike. The Invention thus allows the device to be secured to the substrate removably and without fasteners simply by depressing the plate edge to lever away the projection and allow the withdrawal of buckle from the tongue. The linear assembly of two flat components results in a low profile coupling useful where the volume that can be dedicated to the attachment itself is limited. In summary:

1. The Invention incorporates a perforation or a plurality of perforations in the tongue to allow penetration by a locking mechanism attached to the bracket.

2. The locking mechanism attached to the bracket acts in a rotary motion where the axis of that rotation is perpendicular to the axis of insertion.

3. The locking mechanism consists of a sprung bracket part supporting a projection that entirely penetrates the perforation or plurality of perforations in the tongue and is thus is an internal locking mechanism.

4. Insertion and removal of the tongue requires levering of the locking mechanism such that the projection is rotated away from the tongue.

5. The tongue also incorporates a track or plurality of tracks that guide insertion of the tongue into the bracket and around an immovable feature or plurality of immovable features in the bracket.

6. The tongue can be attached to a substrate such as a watch band or belt or bicycle handlebars and the bracket can be attached to a device.

7. The sprung locking feature is an integral part of the external structure of the bracket.

The detailed description reiterates these properties in visual form.

### DETAILED DESCRIPTION OF THIS INVENTION

The buckle is an ancient design meme. A plurality of designs is possible all involving a bracket and a tongue and a means for locking. The advantage of a buckle is in its low profile of both its components and the resulting coupled assembly. The reason why the assembly is low is that the plane of the inserted tongue is parallel to the plane of the buckle length. This advantage has seen widespread adoption of the buckle in dress and in vehicular applications. Novelty can be established for a new buckle design through consideration of the combination of buckle and tongue and locking device design.

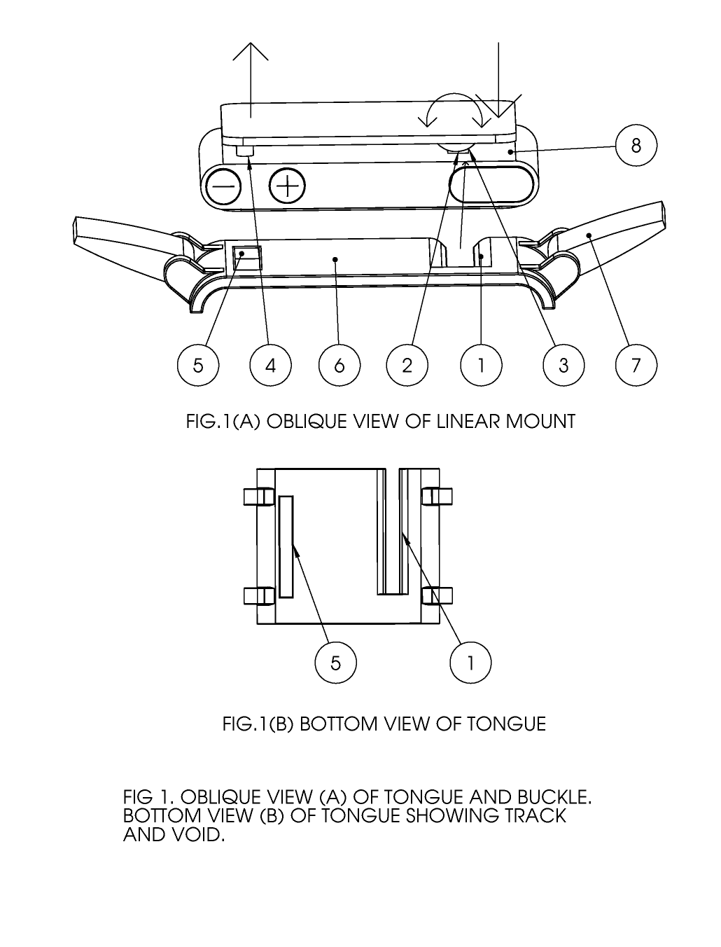

In FIG. 1(a) an oblique view of the buckle shows both a tongue (6) and an empty buckle (8). The tongue is attached to a substrate (7). Illustrated here is a watchband or belt. The tongue incorporates an open track (1) that fits around an immovable feature (2) clip guiding it into place until the tongue can enter the buckle no further. This same immovable feature has an overarching plate with a projection (4) on the tongue side. This projection would impede the progress of the tongue into the buckle so it is levered out of place by a spring mount (3) on the immovable feature. The angle of leverage is perpendicular to the plane of insertion. The projection (8) is lowered by release of the plate. The projection fits into a perforation (5) in the tongue to provide the reversible locking mechanism.

FIG. 1(b) illustrates the nature of the open track (1) that is open at the entry side. This port extends along the axis of insertion until the track comes to an end. The perforation (5) is a place for the locking projection to anchor.

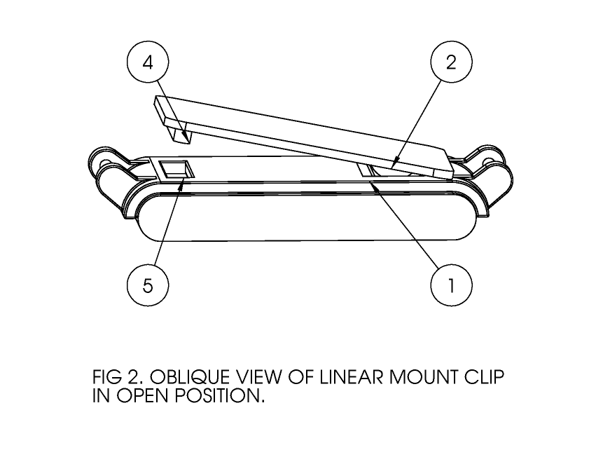

FIG. 2 explicitly illustrates how the open track (1) on the tongue fits around the immovable feature (2) integral to the buckle. Insertion is only possible if the overarching plate suspending a projection (4) is levered out of the way. Once the tongue is inserted the plate can be released to lock the tongue onto the buckle. Depression of the plate once again allows for retraction of the tongue from the buckle.

In practical terms this buckle could be used in a belt or to fashion an electronic device into a watch band.

1. Novelty in this Invention is claimed to lie in the tongue equipped with an open track guide that is distinct from excluding any sprung locking device in the buckle assembly.

2. Novelty is claimed to arise through the separation of the two tongue features of a distinct perforation for anchoring the locking device and a distinct open track that guides the tongue around an immovable bracket feature.

3. Novelty is claimed to arise through the use of the open track guide to prevent misalignment of the device-bearing tongue backward into the buckle bracket.
